(19) United States
(12) Patent Application Publication
(10) Pub. No.: US 2015/0234961 A1
(43) Pub. Date: Aug. 20, 2015

(54) METHOD AND APPARATUS FOR CIRCUIT RELIABILITY AGING

(71) Applicants: Zhichen Zhang, Beijing (CN); Xavier Hours, Tournefeville (FR); Mehul D. Shroff, Austin, TX (US); Chuanzheng Wang, Beijing (CN); Qilin Zhang, Beijing (CN)

(72) Inventors: Zhichen Zhang, Beijing (CN); Xavier Hours, Tournefeville (FR); Mehul D. Shroff, Austin, TX (US); Chuanzheng Wang, Beijing (CN); Qilin Zhang, Beijing (CN)

(21) Appl. No.: 14/558,694

(22) Filed: Dec. 2, 2014

(30) Foreign Application Priority Data
Feb. 17, 2014 (CN) 201410052000.6

(51) Int. Cl. G06F 17/50

(52) U.S. Cl. CPC G06F 17/5036

(57) ABSTRACT

A method for integrated circuit reliability aging simulation includes dividing a target time period into N stages including a first stage and a second stage; obtaining first parameter values of a reliability model for the first stage; performing a first simulation on the circuit based on the reliability model and the first parameter values to obtain first aging results; obtaining second parameter values of the reliability model for the second stage; and performing a second simulation on the circuit based on the reliability model and the second parameter values to obtain second aging results.

### BACKGROUND OF THE INVENTION

The present invention relates to integrated circuits, and more particularly, to a method and apparatus for simulating circuit reliability aging.

Reliability aging has become an important concern in IC design. There are various effects (e.g., Hot Carrier Injection (HCI), Negative Bias Temperature Instability (NBTI), Positive Bias Temperature Instability (PBTI), etc.) related to semiconductor device reliability that may cause the device characteristics to shift, and thus may impact the circuit performance and cause a circuit to fail.

During circuit design, a reliability model is often used to perform simulations on the circuit for a target time period to check reliability issues. The reliability model may include various parameters, such as voltage across gate and source (V_{gs}), voltage across drain and source (V_{ds}), voltage across body and source (V_{bs}), threshold voltage (Vₜₕ), temperature, device type (based on initial Vt and gate dielectric type and thickness] and geometry (channel length and width], etc., for a MOS (metal-oxide-semiconductor] device. For example, a simplified reliability model for Vₜₕ can be expressed as Vₜₕ=f(V_{gs}, V_{ds}, T).

Generally, an integrated circuit is designed to operate for number of years, for example 10 years, taking into account aging and degradation. Therefore, a typical target time period may be, for example, 10 years, and sometimes includes stress (e.g., high temperature, and higher voltage/current). However, conventional reliability aging simulation methods can be inaccurate because they fail to take into account gradual damage aggregation over the target time period. Such degradation can be expressed as, for example, drift (i.e., change in parameter values) of device characteristics.

Generally, conventional aging simulation calculates damage using static device information. That is, the initial parameters, such as characteristics, stress biases, and the like remain unchanged in the simulation for the target period. However, MOS devices gradually degrade over time, and thus, the device characteristics such as I_{ds} and Vₜₕ, may vary over time. Stress biases on the devices also vary over time. Conventional methods, using the static device parameters to calculate degradation, fail to take into account this information and therefore can produce inaccurate results.

Therefore, there exists a need for a more accurate aging simulation method to address or at least alleviate the aforementioned disadvantages of conventional methods.

### BRIEF DESCRIPTION OF DRAWINGS

The accompanying drawings, which are incorporated in and constitute a part of the specification, illustrate embodiments of the invention and, together with the description, serve to explain the principles of the invention. By reading the following detailed description with reference to the accompanying drawings, the present invention can be better understood. In the drawings:

FIG. 1 is a simplified block diagram illustrating a reliability aging simulation method according to an embodiment of the present invention;

FIG. 2 is a block diagram of an exemplary apparatus for reliability aging of a circuit according to an embodiment of the present invention;

FIG. 3 is an exemplary block diagram of an apparatus for reliability aging simulation according to an embodiment of the present invention;

FIG. 4 is a schematic circuit diagram of an exemplary circuit to which an aging reliability test in accordance with an embodiment of the present invention is applied; and

FIGS. 5A and 5B are graphs illustrating results of a method for simulating reliability aging in accordance with the present invention on the circuit of FIG. 4 compared to results of performing conventional aging reliability simulation on the circuit of FIG. 4.

It should be understood that the drawings are merely illustrative and not intended to limit the scope of the present invention. It should also be understood that the drawings are simplified illustrations of the layout plan views so as not to obscure the gist of the present invention.

Other advantages, objects, and aspects of the present invention will become apparent from the following detailed description in conjunction with the drawings.

### DETAILED DESCRIPTION

Hereinafter, the embodiments of the present invention will be described in conjunction with the accompanying drawings.

As used herein, the term “semiconductor device” (or simply “device”) refers to any devices that can operate by partially or fully using semiconductor characteristics, such as a MOS transistor.

According to one embodiment of the present invention, a method for reliability aging simulation of an integrated circuit for a predetermined target time period is provided. The method comprises dividing the target time period into N stages including a first stage and a second stage, where N is a natural number equal to or greater than 2; obtaining first parameter values of a reliability model for the first stage; performing, for the first stage, a first simulation on the circuit based on the reliability model and first parameter values to obtain first aging results; obtaining second parameter values of the reliability model for the second stage based on the first aging results; and performing, for the second stage, a second simulation on the circuit based on the reliability model and second parameter values to obtain second aging results.

According to another embodiment of the present disclosure, an apparatus for performing a reliability aging simulation of a circuit for a target time period is provided. The apparatus comprises a dividing module for dividing the target time period into N stages including a first stage and a second stage, where N is a natural number equal to or greater than 2, and a simulation module for obtaining first parameter values of a reliability model for the first stage; performing a first simulation on the circuit for the first stage based on the reliability model and the first parameter values of the reliability model to obtain first aging results, obtaining second parameter values of the reliability model for the second stage based on the first aging results, and performing a second simulation on the circuit for the second stage based on the reliability model and second parameter values of the reliability model to obtain second aging results.

According to a further embodiment of the present disclosure, an apparatus for reliability aging simulation of a circuit for a target time period is provided. The apparatus comprises a dividing module for dividing the target time period into N stages including a first stage and a second stage, where N is a natural number equal to or greater than 2; a first obtaining module for obtaining first parameter values of a reliability model for the first stage; a first simulation module for performing, for the first stage, a first simulation on the circuit based on the reliability model and the first parameter values of the reliability model to obtain first aging results; a second obtaining module for obtaining second parameter values of the reliability model for the second stage based on the first aging results; and a second simulation module for performing, for the second stage, a second simulation on the circuit based on the reliability model and the second parameter values of the reliability model to obtain second aging results.

As above-mentioned, typically, reliability aging simulation methods/tools take use of a reliability model to simulate the aging of the circuit (and/or devices thereof), with respect to a target time period. The reliability model may involve various parameters, such as, voltage across gate and source (V_{gs}), voltage across drain and source (V_{ds}), voltage across body and source (V_{bs}), threshold voltage (Vₜₕ), temperature, device type (based on initial Vt and gate dielectric type and thickness] and geometry (channel length and width), etc., for a MOS device. However, conventional reliability aging simulation methods/tools use “static” parameter values for the respective parameters of the model, that is, the parameter values are retained unchanged in the simulation with respect to the entire target time.

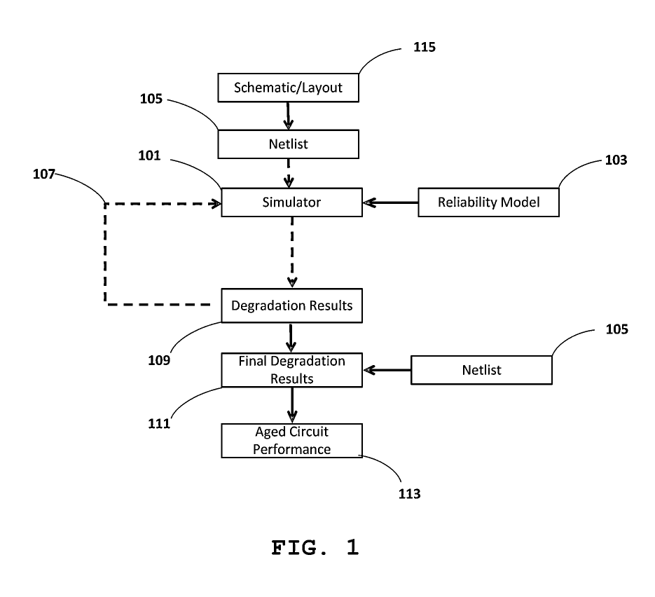

Referring now to FIG. 1, a simplified block diagram for illustrating a method for reliability aging simulation of a circuit for a target time period according to an embodiment of the present disclosure is shown. The method can be implemented by a simulator 101, for example, a Hspice simulator. The target time period for the reliability aging simulation can be divided into N stages including a first stage and a second stage. That is, N is a natural number equal to or greater than 2. Here, it is to be understood that terms such as “first” and “second” are used to arbitrarily distinguish between the elements such terms describe. Therefore, the first and second stages can be any two stages selected from the N stages into which the target time period is divided. Further, the target time period is predetermined for the simulation, and there is no particular limitation on the value of the target time period, although 10 years is named as an example target time period.

Aging simulations can be performed with respect to at least the first and second stages, for example, based on a reliability model 103. The simulations can be performed with respect to each of the N stages of the target time period. The simulation for each stage may generate aging or degradation results 109. As those skilled in the art would appreciate, the aging simulation can be performed with respect to device(s) of the circuit. In some embodiments, the aging results 109 can be drift parameter values calculated with respect to a current stage out of the N stages of the target time period. For example, the aging results can be a drift value of Vₜₕ (ΔVₜₕ), which may be due to Hot Carrier Injection (HCI) effects, or Bias Temperature Instability (BTI) effects, for example, as aging simulation is proceeding through this current stage. Incidentally, it is also contemplated that the aging results can be drifted Vₜₕ, that is, the previous Vₜₕ which is the threshold voltage at a time point immediately before the current stage (e.g., the initial value (Vₜₕ₀)) plus the drift through the current stage, and thus, the drifted Vₜₕ can be expressed as: V_{Th0}+ΔVₜₕ, for example, for the first stage. Therefore, the aging results may include various expressions as long as they are relative to or based on the drift(s) of the parameter(s).

For example, the target time period is divided into two stages. At the first stage, first parameter values of the reliability model 103 for the first stage are obtained. The first parameter values can be initial parameter values for the reliability aging simulation (e.g., Vₜₕ₀), which would otherwise maintain constant in the conventional methods/tools. Through the simulation for the first stage, first aging results (e.g., Vₜₕ or ΔVₜₕ) are obtained.

The first aging results from the first stage can be fed back 107 for the second stage simulation. In a preferred embodiment, the first aging results correspond to drift parameter values, the first aging results are combined with the first parameter values to obtain second parameter values of the reliability model 103 for the second stage. In another preferred embodiment, the first aging results correspond to drifted parameter values, the first aging results are directly used as second parameter values of the reliability model for the second stage. Thus, the second parameter values for the second stage are obtained based on the first aging results. Then, the second stage simulation is performed for the circuit based on the reliability model 103 and second parameter values of the reliability model 103 to obtain second aging results.

In the case where the target time period includes more than two stages, that is, the target time period is divided into N stages, wherein N is a natural number equal to or greater than 3, a process similar to the one described above is repeated for each of the additional iterations. In such a case, with the above-mentioned second stage, i^{th} parameter values of the reliability model for an i^{th} stage can be obtained based on the (i−1)^{th} aging results, where i denotes a natural number ranging from 3 to N.

Likewise, the i^{th} parameter values can be obtained by combining (i−1)^{th} aging results and (i−1)^{th} parameter values. For the i^{th} stage of the target time period, an i^{th} stage simulation can be performed for the circuit based on the reliability model and i^{th} parameter values of the reliability model, and i^{th} aging results are obtained.

In a preferred embodiment, the i^{th} aging results are drift parameter values calculated with respect to the i^{th} stage. For example, the i^{th} aging results are drift of threshold voltage, ΔVₜₕ_{_{—}}ᵢ, occurred in the i^{th} stage simulation. In another preferred embodiment, the i^{th} aging results are drifted parameter values calculated as aging simulation is proceeding until the end of the i^{th} stage. In such a case, for example, the i^{th} aging results can be expressed as

$${\sum }_{j = 1}^{i} Δ {V}_{th \_ j} + {V}_{th 0} .$$

(i+1)^{th} parameter values of the reliability model for the next (i+1)^{th}) stage can thus be obtained. It is to be noted that the drifted parameter values (such as, the threshold voltage) calculated as the reliability aging simulation is proceeding till the end of the N^{th} stage can include a sum of the initial parameter value and drift parameter values of each stages ahead of the N^{th} stage, and thus, can be expressed as

$${\sum }_{j = 1}^{N} Δ {V}_{th \_ j} + {V}_{th 0} ,$$

for the parameter of threshold voltage.

In a preferred embodiment, the simulation is performed based on a netlist 105 of the circuit. The netlist 105 can be generated from a schematic/layout 115 of the circuit, for example, by means of netlist generating tools known in the art.

Through the simulation iterations described above, final degradation results 111 are obtained, such as, the drifted parameter values calculated from the N^{th} stage. Based on the final degradation results, an aged circuit performance 113 is generated by a circuit performance simulation, as known in the art.

The simulation can be performed before the circuit is fabricated so that if the simulation reveals a poor quality circuit, which means that the circuit may fail or shift to unacceptable levels in a short time period, then the circuit will be modified in response to the simulation results.

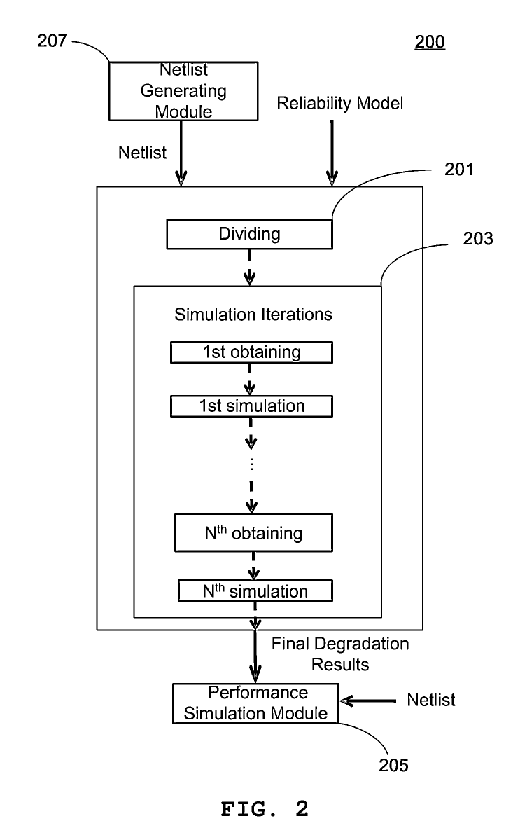

FIG. 2 is a block diagram of an apparatus 200 for reliability aging simulation of a circuit according to an embodiment of the present disclosure. The above-mentioned methods can be embodied by the apparatus 200. Similarly, the reliability aging simulation can be directed to a target time period, for example, 10 years under stress. The apparatus 200 includes a dividing module 201 and a simulation module 203.

The dividing module 201 divides the target time period into multiple (N>=2) stages, including a first stage and a second stage. The simulation module 203 obtains first parameter values of the reliability model for the first stage, and performs a first simulation on the circuit for the first stage based on a reliability model and the first parameter values of the reliability model to obtain first aging results. In a preferred embodiment, initial parameter values for the reliability aging simulation are obtained as the first parameter values for the first stage.

The simulation module 203 further obtains second parameter values of the reliability model for the second stage based on the first aging results, and performs a second simulation on the circuit for the second stage based on the reliability model and second parameter values to obtain second aging results. The second parameter values for the second stage can be obtained by combining the first aging results and the first parameter values.

In a preferred embodiment, the simulation module 203 obtains i^{th} parameter values of the reliability model for i^{th} stage based on (i−1)^{th} aging results, where i denotes a natural number from 3 to N, and performs an i^{th} simulation on the circuit for an i^{th} stage of the target time period based on the reliability model and i^{th} parameter values of the reliability model to obtain i^{th} aging results. In a preferred embodiment, the i^{th} parameter values are obtained by combining the (i−1)^{th} aging results and (i−1)^{th} parameter values.

It is to be noted that the drifted parameter values calculated as the reliability aging simulation is proceeding until the end of the N^{th} stage can include a sum of the initial parameter value and drift parameter values of each stages ahead of the N^{th} stage.

Through the simulation iterations described above, final degradation results are obtained, such as, the above-mentioned drifted parameter values calculated from the N^{th} stage.

In a preferred embodiment, the apparatus 200 further comprises a performance simulation module 205 for performing a simulation using the final degradation results.

In another preferred embodiment, the apparatus 200 further comprises a netlist generating module 207 for generating the netlist of the circuit based on a layout and/or schematic of the circuit. The simulations can be performed at least partially based upon the netlist.

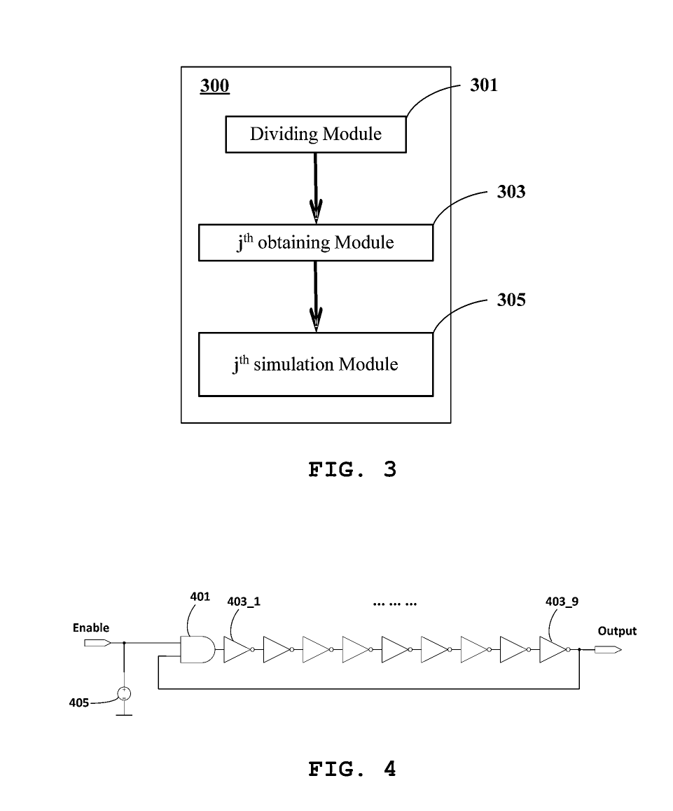

FIG. 3 is a block diagram of an apparatus 300 for reliability aging simulation of a circuit, according to another embodiment of the present invention. The method of the present invention can be embodied by the apparatus 300. The apparatus 300 includes a dividing module 301 for dividing the target time period into N stages including a first stage and a second stage, where N is a natural number equal to or greater than 2.

The apparatus 300 further includes a j^{th} obtaining module 303 for obtaining j^{th} parameter values of a reliability model for a j^{th} stage, and a j^{th} simulation module 305 for performing a j^{th} simulation on the circuit for a j^{th} stage of the target time period based on the reliability model and j^{th} parameter values of the reliability model, to obtain j^{th} aging results, where j denotes a natural number from 1 to N.

Specifically, the apparatus 300 includes a first obtaining module for obtaining first parameter values of the reliability model for the first stage, and a first simulation module for performing a first simulation on the circuit for the first stage based on the reliability model and the first parameter values of the reliability model to obtain first aging results.

The apparatus 300 further includes a second obtaining module for obtaining second parameter values of the reliability model for the second stage based on the first aging results, and a second simulation module for performing a second simulation on the circuit for the second stage based on the reliability model and second parameter values of the reliability model to obtain second aging results. In a preferred embodiment, the apparatus further comprises an i^{th} obtaining module for obtaining i^{th} parameter values of the reliability model for an i^{th} stage based on (i−1)^{th} aging results, where i denotes a natural number from 3 to N, and an i^{th} simulation module for performing, for an i^{th} stage of the target time period, an i^{th} simulation on the circuit based on the reliability model and i^{th} parameter values of the reliability model to obtain i^{th} aging results.

FIG. 4 is a schematic circuit diagram of an exemplary circuit 400 to which an aging reliability test in accordance with an embodiment of the present invention is applied. For example, the circuit 400 may be a ring oscillator including an enable terminal, an output terminal, an AND gate 401 and nine NOT gates or inverters 403_1 to 403_9 connected in series between the enable terminal and the output terminal. An output of the ninth NOT gate 403_9 is fed back to an input of the AND gate 401, while another input of the AND gate 401 is connected to the enable terminal. In addition, the enable terminal is connected to a voltage source 405.

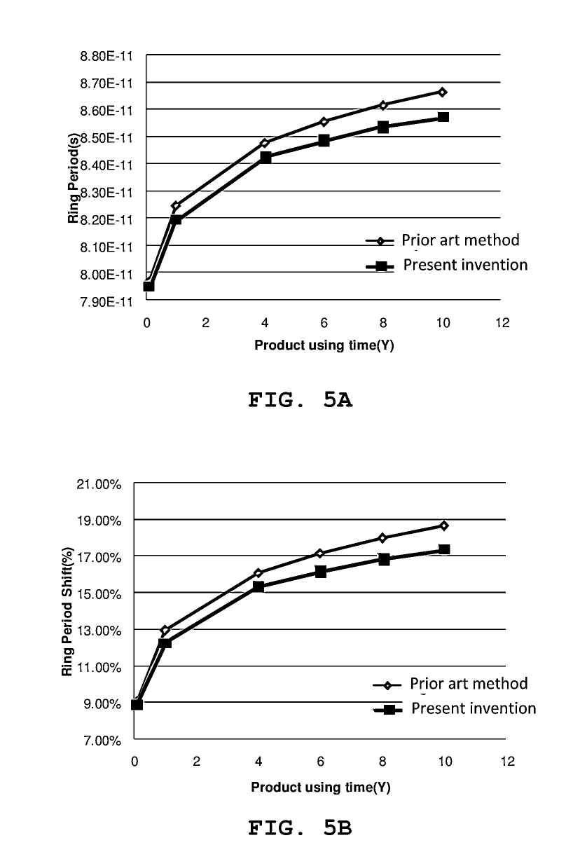

FIGS. 5A and 5B are graphs illustrating results of performing a method of the present invention on the circuit of FIG. 4 compared to results of performing conventional aging reliability on the circuit of FIG. 4. The abscissas of FIGS. 5A and 5B represent the circuit using time in years (Y), while the ordinates of FIG. 5A represent ring period in seconds (s) and the ordinates of FIG. 5B represent ring period shift (%). As shown in FIGS. 5A and 5B, the ring period drift for circuits simulated and modified in accordance with the present invention is reduced as compared to the case where the conventional method is applied. It therefore is evident that deterioration of the performance of the circuit can be accurately simulated and estimated according to the present invention.

The present invention can be embodied in the form of methods and apparatuses for practicing those methods. The present invention can also be embodied in the form of program code embodied in tangible media, such as magnetic recording media, optical recording media, solid state memory, CD-ROMs, or any other non-transitory machine-readable storage medium, where, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, where, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It should be appreciated by those of ordinary skill in the art that any block diagrams herein represent conceptual views of illustrative module embodying the principles of the invention.

Similarly, it will be appreciated that any flow charts or block diagram represent various processes that may be substantially represented in computer readable medium and so executed by a computer or processor, whether or not such computer or processor is explicitly shown.

As is apparent to one skilled in the art, various functions of circuit elements may also be implemented as processing blocks in software. Such software may be employed in, for example, a digital signal processor, micro-controller, general purpose computer, or the like.

It will be further understood that various changes in the details, materials, and arrangements of the parts which have been described and illustrated in order to explain the nature of this invention may be made by those skilled in the art without departing from the scope of the invention as expressed in the following claims.

Although the elements in the following method claims are recited in a particular sequence with corresponding labelling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The use of the phrase “in one embodiment” in various places in the specification is not necessarily referring to the same embodiment, nor are separate or alternative embodiments necessarily mutually exclusive of other embodiments.

Because the apparatus implementing the method of the present invention is, for the most part, composed of electronic modules and circuits known to those skilled in the art, circuit details have not been explained in any greater extent than that considered necessary for the understanding and appreciation of the underlying concepts of the present invention and in order not to obfuscate or distract from the teachings of the present invention.

Furthermore, those skilled in the art will recognize that boundaries between the functionality or steps of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

The embodiments of the present invention have been described above with reference to the accompanying drawings. However, it should be understood that these embodiments are merely illustrative and are not limitations for the claims of the application. The embodiments of the present invention can be freely combined without going beyond the scope of the present invention. Moreover, one of ordinary skill in the art can make various modifications to the embodiments and details of the present invention based on the teachings of the present invention, without departing from the scope of the present invention, and thus, all these modifications are intended to be embraced within the spirit and scope defined by the attached claims.

1. A method for reliability aging simulation of a circuit for a predetermined target time period, the method comprising:
dividing the target time period into N stages including a first stage and a second stage, where N is a natural number equal to or greater than 2;
obtaining first parameter values of a reliability model for the first stage;
performing, for the first stage, a first simulation on the circuit based on the reliability model and the first parameter values to obtain first aging results;
obtaining second parameter values of the reliability model for the second stage based on the first aging results; and
performing, for the second stage, a second simulation on the circuit based on the reliability model and the second parameter values to obtain second aging results.

2. The method of claim 1, wherein:
obtaining the first parameter values comprises obtaining initial parameter values for the reliability aging simulation as the first parameter values; and
obtaining the second parameter values comprises combining the first aging results and the first parameter values to obtain the second parameter values for the second stage.

3. The method of claim 1, wherein the first aging results are drift parameter values calculated with respect to the first stage, or drifted parameter values calculated as the reliability aging simulation is proceeding to the end of the first stage, and
the second aging results are drift parameter values calculated with respect to the second stage, or drifted values of the respective parameters calculated as the reliability aging simulation is proceeding to the end of the second stage.

4. The method of claim 1, further comprising:
obtaining i^{th} parameter values of the reliability model for an i^{th} stage based on (i−1)^{th} aging results, where i denotes a natural number from 3 to N; and
performing, for the i^{th} stage of the target time period, an i^{th} simulation on the circuit based on the reliability model and the i^{th} parameter values to obtain i^{th} aging results.

5. The method of claim 4, wherein obtaining the i^{th} parameter values comprises combining the (i−1)^{th} aging results and (i−1)^{th} parameter values to obtain i^{th} parameter values of the reliability model for the i^{th} stage.

6. The method of claim 4, wherein the i^{th} aging results are drift parameter values calculated with respect to the i^{th} stage, or drifted parameter values calculated as the reliability aging simulation is proceeding until the end of the i^{th} stage.

7. The method of claim 1, further comprising:
performing a performance simulation based on drifted parameter values calculated as the reliability aging simulation is proceeding until the end of an N^{th} stage.

8. The method of claim 1, wherein the reliability aging simulation is performed based on a netlist of the circuit, and the method further comprises:
generating a netlist of the circuit based on at least one of a schematic or layout of the circuit.

9. An apparatus for performing a reliability aging simulation of a circuit for a target time period, the apparatus comprising:
a dividing module for dividing the target time period into N stages including a first stage and a second stage, where N is a natural number equal to or greater than 2; and
a simulation module for:
obtaining first parameter values of a reliability model for the first stage;
performing, for the first stage, a first simulation on the circuit based on the reliability model and the first parameter values to obtain first aging results;
obtaining second parameter values of the reliability model for the second stage based on the first aging results; and
performing, for the second stage, a second simulation on the circuit based on the reliability model and second parameter values to obtain second aging results.

10. The apparatus of claim 9, wherein:
obtaining the first parameter values comprises obtaining initial parameter values for the reliability aging simulation as the first parameter values; and
obtaining the second parameter values comprises combining the first aging results and the first parameter values to obtain the second parameter values.

11. The apparatus of claim 9, wherein
the first aging results are drift parameter values calculated with respect to the first stage, or drifted parameter values calculated as the reliability aging simulation is proceeding until the end of the first stage, and
the second aging results are drift parameter values calculated with respect to the second stage, or drifted parameter values calculated as the reliability aging simulation is proceeding until the end of the second stage.

12. The apparatus of claim 9, wherein the simulation module is further configured for:
obtaining i^{th} parameter values of the reliability model for an i^{th} stage based on (i−1)^{th} aging results, where i denotes a natural number from 3 to N; and
performing, for an i^{th} stage of the target time period, an i^{th} simulation on the circuit based on the reliability model and the i^{th} parameter values of the reliability model to obtain i^{th} aging results.

13. The apparatus of claim 12, wherein said obtaining the i^{th} parameter values comprises:
combining the (i−1)^{th} aging results and (i−1)^{th} parameter values to obtain the i^{th} parameter values of the reliability model for the i^{th} stage.

14. The apparatus of claim 12, wherein the i^{th} aging results are drift parameter values calculated with respect to the i^{th} stage, or drifted parameter values calculated as the reliability aging simulation is proceeding till the end of the i^{th} stage.

15. The apparatus of claim 14, further comprising:
a performance simulation module for performing a performance simulation based on drifted parameter values calculated as the reliability aging simulation is proceeding till the end of an N^{th} stage.

16. The apparatus of claim 9, further comprising:
a netlist generating module for generating the netlist of the circuit based on at least one of a schematic or layout of the circuit,
wherein the reliability aging simulation are performed based upon the netlist.

17. An apparatus for reliability aging simulation of a circuit for a target time period, the apparatus comprising:
a dividing module for dividing the target time period into N stages including a first stage and a second stage, where N is a natural number equal to or greater than 2;
a first obtaining module for obtaining first parameter values of a reliability model for the first stage;
a first simulation module for performing, for the first stage, a first simulation on the circuit based on the reliability model and the first parameter values to obtain first aging results;
a second obtaining module for obtaining second parameter values of the reliability model for the second stage based on the first aging results; and
a second simulation module for performing, for the second stage, a second simulation on the circuit based on the reliability model and the second parameter values to obtain second aging results.

18. The apparatus of claim 17, wherein:
obtaining the first parameter values comprises obtaining initial parameter values for the reliability; and
obtaining the second parameter values comprises combining the first aging results and the first parameter values.

19. The apparatus of claim 17, wherein the first aging results are drift parameter values calculated with respect to the first stage, or drifted parameter values calculated as the reliability aging simulation is proceeding until the end of the first stage, and
the second aging results are drift parameter values calculated with respect to the second stage, or drifted parameter values calculated as the reliability aging simulation is proceeding until the end of the second stage.

20. The apparatus of claim 17, further comprises:
an i^{th} obtaining module for obtaining i^{th} parameter values of the reliability model for an i^{th} stage based on (i−1)^{th} aging results, where i denotes a natural number from 3 to N; and
an i^{th} simulation module for performing, for an i^{th} stage of the target time period, an i^{th} simulation on the circuit based on the reliability model and the i^{th} parameter values of the reliability model to obtain i^{th} aging results.
